(19) United States
(12) Patent Application Publication
(10) Pub. No.: US 2013/0021536 A1
(43) Pub. Date: Jan. 24, 2013

(54) VIDEO DISPLAY APPARATUS, INFORMATION REPRODUCTION METHOD, AND INFORMATION REPRODUCTION APPARATUS

(71) Applicant: Masahiro Kamida, Tokyo (JP)

(72) Inventor: Masahiro Kamida, Tokyo (JP)

(73) Assignee: KABUSHIKI KAISHA TOSHIBA, Tokyo (JP)

(21) Appl. No.: 13/488,904

(22) Filed: Jun. 5, 2012

(30) Foreign Application Priority Data
Jul. 21, 2011 (JP) 2011-160345

(51) Int. Cl. H04N 5/66; H04N 21/40

(52) U.S. Cl. 348/739; 725/131; 348/E05.133

(57) ABSTRACT

According to one embodiment, information reproduction apparatus including, reception module configured to receive at least one of video and audio input by source device via bidirectional interface, output module configured to output audio received by reception module to external audio output device via bidirectional interface, detection module configured to detect connection made between source device and external audio output device via bidirectional interface, and controller configured to stop of output of audio from output module to external audio output device if detection module detects connection between source device and external audio output device.

### CROSS-REFERENCE TO RELATED APPLICATIONS

This application is based upon and claims the benefit of priority from prior Japanese Patent Application No. 2011-160345, filed Jul. 21, 2011, the entire contents of which are incorporated herein by reference.

### FIELD

Embodiments described herein relate generally to a video display apparatus connected via a bidirectional communication interface, an information reproduction method, and an information reproduction apparatus.

### BACKGROUND

The High-definition Digital Media Interface (HDMI) and the like is widely utilized as a bidirectional communication interface.

For connections using HDMI, following an HDMI-Consumer Electronics Control (HDMI-CEC, defined in Version 1.2) established subsequently to HDMI, an audio return channel (ARC, defined in Version 1.4), HDMI Ethernet Channel (HEC, defined in Version 1.4), and the like have been established; HEC enables control signals to be delivered via Ethernet (registered trademark).

In regard to reproduction of video and audio, there has been a demand to reproduce higher-grade audio using, for example, an audiovisual (AV) amplifier and a speaker connected to the AV amplifier.

On the other hand, when video and audio signals are transmitted using an HDMI cable that conforms to the HDMI standard, if an audio return channel (ARC) line is detected, then in connection with a standard for Consumer Electronics Control (CEC) lines, audio signals are transmitted via ARC (audio signals specified based on the reproduction capability of a television apparatus).

That is, according to the current HDMI standard, even if another HDMI cable is provided for audio signals, audio signals reproduced by the AV amplifier are in a grade equal to that of audio signals reproduced by the television apparatus via the ARC line.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of connections between a video reproduction apparatus to which an embodiment is applied and peripheral apparatuses, according to an embodiment;

FIG. 2 is an exemplary diagram showing an example of connections between a video reproduction apparatus to which an embodiment is applied and peripheral apparatuses according to an embodiment;

FIG. 3 is an exemplary diagram showing an example of connections between a video reproduction apparatus to which an embodiment is applied and peripheral apparatuses, according to an embodiment;

FIG. 4 is an exemplary diagram showing an example of control commands between a video reproduction apparatus to which an embodiment is applied, a recording apparatus, and an AV amplifier, according to an embodiment;

FIG. 5 is an exemplary diagram showing an example of an input association database to which an embodiment is applied, according to an embodiment;

FIG. 6 is an exemplary diagram showing an example of physical addresses based on an input association database to which an embodiment is applied, according to an embodiment;

FIG. 7 is an exemplary diagram showing an example of an input association database to which an embodiment is applied, according to an embodiment;

FIG. 8 is an exemplary diagram showing an example of control of output of an audio output between a video reproduction apparatus and an external audio output device, according to an embodiment;

FIG. 9A is an exemplary diagram showing an example of an interface screen display for input switching to which an embodiment is applied, according to an embodiment;

FIG. 9B is an exemplary diagram showing an example of an interface screen display for input switching to which an embodiment is applied, according to an embodiment;

FIG. 10 is an exemplary diagram showing an example of a device to which an embodiment is applied, according to an embodiment; and

FIG. 11 is an exemplary diagram showing an example of a device to which an embodiment is applied, according to an embodiment.

### DETAILED DESCRIPTION

Various embodiments will be described hereinafter with reference to the accompanying drawings. In general, according to one embodiment, an information reproduction apparatus comprising: a reception module configured to receive at least one of video and audio input by a source device via a bidirectional interface; an output module configured to output the audio received by the reception module to external audio output device via the bidirectional interface; a detection module configured to detect a connection made between the source device and the external audio output device via the bidirectional interface; and a controller configured to stop of output of the audio from the output module to the external audio output device if the detection module detects the connection between the source device and the external audio output device.

Embodiments will be described below with reference to the drawings.

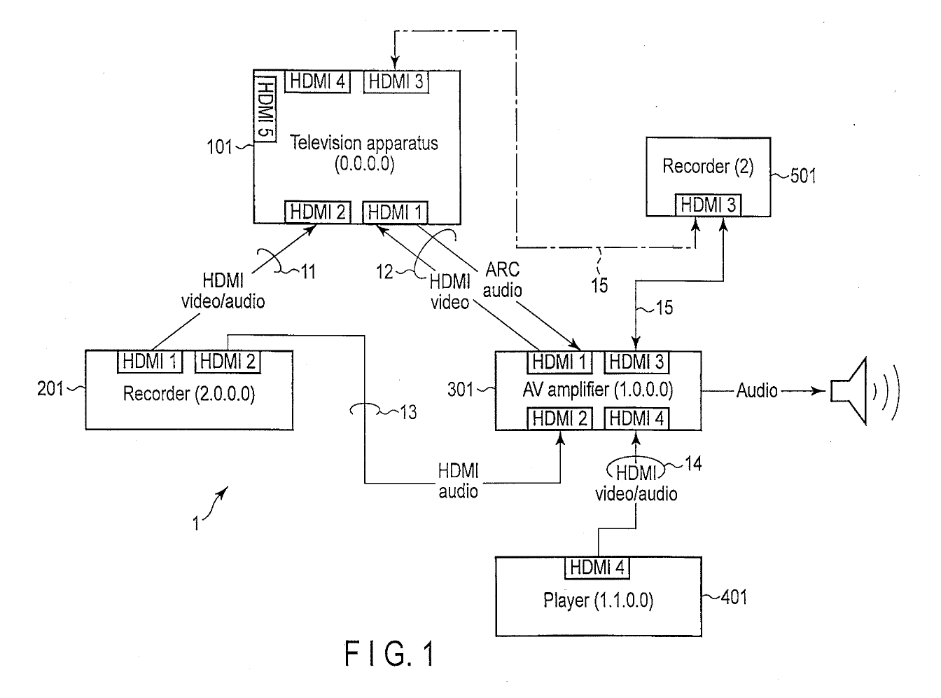

FIG. 1 shows an example of an information reproduction apparatus 1 in which a video reproduction apparatus (television apparatus) 101, a recording and reproduction apparatus (recorder) 201, and an audiovisual (AV) amplifier 301 are connected together by cables that conform to a bidirectional communication interface standard, for example, the High-definition Digital Media Interface (HDMI) standard. The television apparatus (video reproduction apparatus) 101 may be, for example, a integral recording and reproduction apparatus with an integrated recording apparatus or a display apparatus to which a recording apparatus can be integrally connected. The recorder (recording and reproduction apparatus) 201 may be, for example, a player apparatus (information reproduction apparatus) utilized to reproduce programs/content. In the information reproduction apparatus shown in FIG. 1, a player 401 is connected to the AV amplifier 301 by way of example. Furthermore, in the system, a second recorder (second recorder) 501 is connected to the television apparatus 101 or the AV amplifier 301, by way of example.

The television apparatus (video information and audio information reproduction apparatus) 101 is referred to as a sink device. The recorder (recording and reproduction apparatus/audio information output apparatus) 201 is referred to as a source device with respect to the sink device. The AV amplifier 301 is referred to as a repeater device or an external audio output device, or an AV system (AV controller). For example, plural sets of speakers may be connected to the AV amplifier 301 so that a user can switch among the sets of speakers.

The HDMI-CEC standard relates to a bidirectional interface, and HDMI cables are nondirectional (involve no rules for connecting connectors at the opposite ends thereof to relevant apparatuses). However, in the individual apparatuses, for signals input through a port (connector connected to an HDMI cable) or signals output to a port (connector), the connector functions (fulfills its role) as a reception side (input section) or a transmission side (output section).

Thus, more specifically, the HDMI ports in the above-described television apparatus 101, recorder 201, AV amplifier 301, player 401, and recorder (2) 501 are separated into input (reception) ports and output (transmission) ports (the HDMI ports have separate roles as input and output ports). The “inputs (reception)” are distinguished from the “outputs (transmission)” as follows:

Television apparatus 101:
All HDMI ports→HDMI inputs

Recorder 201:
HDMI port to which a cable 11 is connected→HDMI output 1
HDMI port to which a cable 13 is connected→HDMI output 2

AV amplifier 301:
HDMI port to which a cable 12 is connected→HDMI output
HDMI port to which cable 13 is connected→HDMI input 1
HDMI port to which a cable 14 is connected→HDMI input 3
HDMI port to which a cable 15 is connected→HDMI input 2

Player 401:
HDMI port to which cable 14 is connected→HDMI output

Recorder (2) 501:
HDMI port to which the television apparatus 101 is connected→HDMI output 1
HDMI port to which the AV amplifier 301 is connected→HDMI output 2.

Elements/components described to as “module” below may be obtained by hardware or may be obtained by software using, for example, a microcomputer (processor, CPU), etc. Furthermore, the above-described apparatuses are assumed to be able to process digital information (content/programs/titles [programs]) coded in accordance with predetermined standards, for example, Moving Picture Experts Group (MPEG)-1, -2, -4 (H. 264/AVC) for video (moving images), for example, MPEG Audio layer-3 (MP3) for audio (sounds), and for example, Joint Photographic Experts Group (JPEG) for stills (still images).

The television apparatus 101 brings a physical address [0. 0. 0. 0] which includes at least a plurality of HDMI ports (input and output sections) connected to HDMI cables and an HDMI processing section that conforms to the HDMI standard. In the description below, the television apparatus 101 includes five HDMI ports, that is, a first HDMI port to a fifth HDMI port.

The recorder 201 brings a physical address [2. 0. 0. 0] which includes at least a plurality of HDMI ports (input and output sections) connected to HDMI cables and an HDMI processing section that conforms to the HDMI standard. In the description below, the recorder 201 comprises two HDMI ports, that is, a first HDMI port and a second HDMI port.

The AV amplifier 301 brings a physical address [1. 0. 0. 0]) includes at least a plurality of HDMI ports (input and output sections) connected to HDMI cables and an HDMI processing section that conforms to the HDMI standard. In the description below, the AV amplifier 301 comprises four HDMI ports, that is, a first HDMI port to a fourth HDMI port.

The HDMI ports in the television apparatus 101, recorder 201, and an AV amplifier 301 are connected together as follows. One of the HDMI ports in the television apparatus 101 is connected to one of the HDMI ports in the recorder 201 by the first HDMI cable 11. One of the HDMI ports in the television apparatus 101 is connected to one of the HDMI ports in the AV amplifier 301 by the second HDMI cable 12. One of the HDMI ports in the recorder 201 is connected to one of the HDMI ports in the AV amplifier 301 by the third HDMI cable 13. Furthermore, the player apparatus 401 brings a physical address [1. 1. 0. 0] and the AV amplifier 301 are connected together by the fourth HDMI cable 14. The second recorder (recorder 2) 501 brings a physical address [1. 2. 0. 0] and one of the television apparatus 101 or the AV amplifier 301 are connected together by the fifth HDMI cable 15. The physical addresses of each of correspond to the addresses of the respective devices on the HDMI connections.

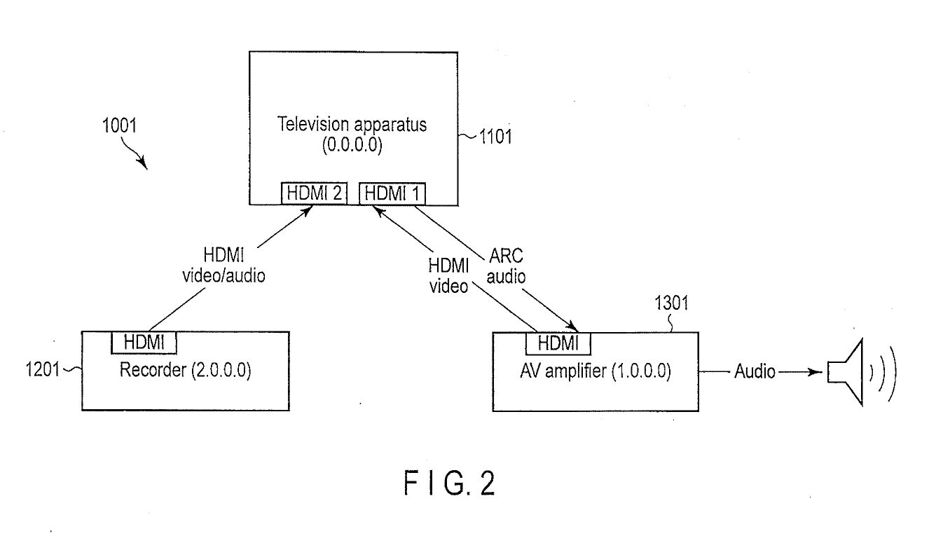

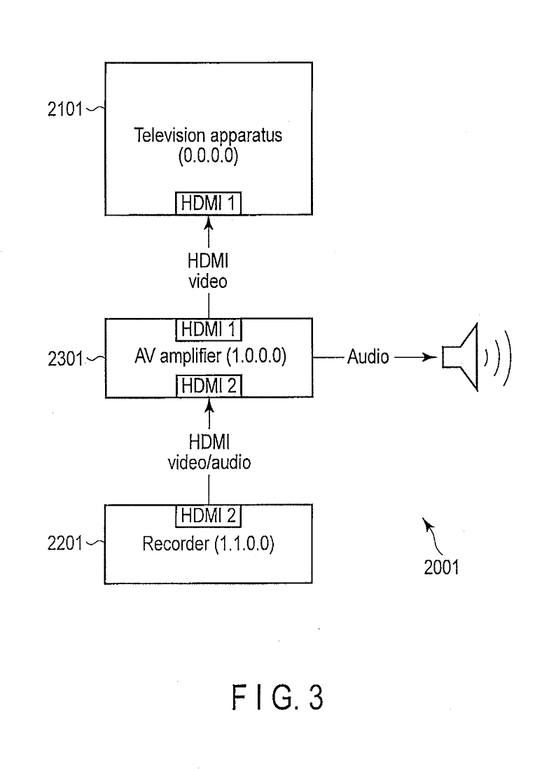

Compared to the connections illustrated in FIG. 2 and FIG. 3, an example of connection shown in FIG. 1 includes, in addition to the HDMI cable 11, which connects the recorder 201 and the television apparatus 101 together (a first connection), a second connection involving the HDMI cable 13, which connects the recorder 201 and the AV amplifier 301. The second connection enables video and audio signals (in the example illustrated in FIG. 1, audio signals because the second connection involves the AV amplifier) to be transmitted independently of the first connection, in which the recorder 201 and the television apparatus 101 are connected together.

That is, under the current HDMI standard, in connection with a standard for Consumer Electronics Control (CEC) lines, if an audio return channel (ARC) line is detected, audio signals are transmitted via ARC (audio signals specified based on the reproduction capability of the television apparatus). Thus, even if audio signals that can be reproduced by the AV amplifier 301 are in a higher grade than those which can be reproduced by the television apparatus 101, the audio signals that can be reproduced by the AV amplifier 301 are in a grade equal to that of audio signals reproduced by the television apparatus 101 via the ARC line.

That is, in the connections shown in FIG. 1, when a user enters a choice and a decision for an input switching display included in user interface (UI) displays provided on a screen of the television apparatus 101 or operates an input switching key on a remote controller terminal to select the recorder 201, connected to the television apparatus 101 by the HDMI cable 11, the following operation is performed:
TV→[Broadcast] [[Routing Change]] [*. * * *] ([*. *. *. *] is a physical address that avoids specifying a particular device) is supplied (transmitted) to a CEC line; and
TV→[Broadcast] [[Set Stream Path>]] [2. 0. 0. 0] allows the recorder 201 (which is provided with the physical address [2. 0. 0. 0] as shown in FIG. 1) to be selected from a connection device list pre-stored in the television apparatus 101.

The selected recorder 201 (in actuality, one of the devices connected via HDMI which is identified by the physical address [2. 0. 0. 0]) receives:
recorder→[Broadcast] <[[Active Source]] [2. 0. 0. 0]”.

In accordance with the HDMI standard, when powered on, the recorder 201, which is an source device under the HDMI standard, normally reads the physical address (of the television apparatus 101) recorded in Extended Display Identification Data (EDID) on the television apparatus 101, from the television apparatus 101, which is a sink device under the HDMI standard. The recorder 201 then notifies the CEC line of an input cooperation via a [[Report Physical Address]] command.

Thus, upon receiving this command, the AV amplifier 301 changes its AV selector according to the physical address of the parameter (the AV amplifier 301 selects, from the connections shown in FIG. 1, the HDMI cable 12, connected to the television apparatus 101, and the corresponding HDMI port for video signals, and the HDMI cable 13, connected to the recorder 201, and the corresponding HDMI port for audio signals). However, in accordance with the standard for CEC, the television apparatus 101 selects the ARC line (HDMI cable 12 as a path through which the television apparatus 101 inputs audio signals to the AV amplifier 301.

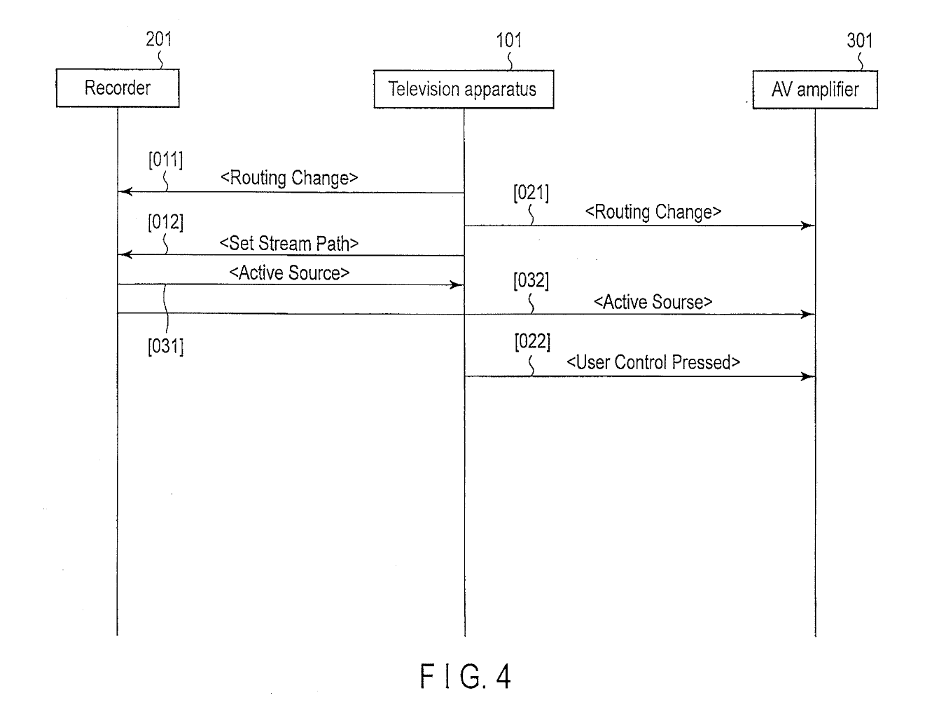

Thus, as illustrated in FIG. 4, the present embodiment involves the command for switching the input port (HDMI port) for audio signals to the AV amplifier 301, and the television apparatus 101, serving as the sink device, provides the command for switching the input of audio signals to the AV amplifier 301 to suppress the selection of ARC in accordance with the CEC standard. Then, if, for example, audio signals that can be reproduced by the AV amplifier 301 are in a higher grade than those which can be reproduced by the television apparatus 101, the audio signals reproduced by the AV amplifier 301 can maintain the grade of the audio signals as output by the recorder 201.

More specifically, when the user enters a choice and a decision for the input switching display included in the user interface (UI) displays provided on the screen of the television apparatus 101 or operates the input switching key on the remote controller terminal to select the recorder 201, connected to the television apparatus 101 by the HDMI cable 11, the following operation is performed. The television apparatus 101 broadcasts to the recorder 201:
[Routing Change] [*. *. *. *]
(“Broadcast” [Routing Change] [*. *. *. *]) [011].

Similarly, the television apparatus 101 broadcasts to the AV (audio) amplifier 301:
[Routing Change] [*. *. *. *]
(“Broadcast” [Routing Change] [*. *. *. *]) [021].

In this regard, [“Broadcast” [Routing Change]] [*. *. *. *] shown at [011] and [021] described above with reference to FIG. 4 is broadcast (simultaneously transmitted). Since, separately shows operations for the respective transmission targets for convenience, and the present embodiment does not involve the illustrated time series, in FIG. 4.

Furthermore, the television apparatus 101 broadcasts to the recorder 201:
[Set Stream Path] [2. 0. 0. 0]
(“Broadcast” [Set Stream Path] [2. 0. 0. 0]) [012].

The recorder 201 broadcasts to the television apparatus 101 and the AV amplifier 301:
[[Active Source]] [2. 0. 0. 0]
(“Broadcast” [Set Stream Path] [2. 0. 0. 0]) [031] and
[[Active Source]] [2. 0. 0. 0]
(“Broadcast” [Set Stream Path] [2. 0. 0. 0]) [032]. In this regard, “[Routing Change] [*. *. *. *]” shown at [011] and [021] described above and “[Active Source] [2. 0. 0. 0] [Broadcast]” shown at [031] and [032 ] correspond to operations for the respective transmission targets for convenience, and the present embodiment does not involve the illustrated time series.

Additionally, the television apparatus 101 transmits to the AV amplifier 301:
[User Control Pressed] [Select A/V Input Function]
(“transmits” [User Control Pressed] [Select A/V Input Function]) [022].

The television apparatus 101 issues a HDMI-CEC command “switch to input ‘X’” attached to “[[User Control Pressed]]>[Select A/V Input Function]” to the AV amplifier 301 through the audio input terminal, wherein the number in “X” serves as a parameter.

At this time, based on the leading data of the physical address added to the HDMI-CEC command “switch to input ‘X’” (in this example, the leading address is “2” because the physical address of the recorder 201 is [2. 0. 0. 0]), the HDMI port number (expressed by 4 bits; any of “0X00 to 0XFF”) of the television apparatus 101 to which a new viewing device (content source) is connected is determined.

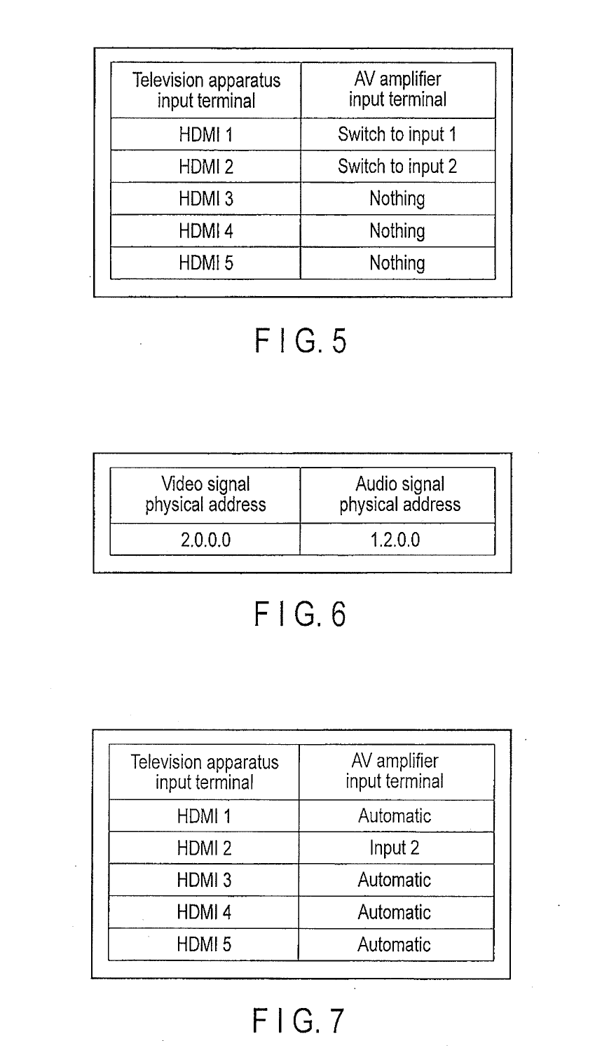

More specifically, an input association database held by the television apparatus 101 as illustrated below with reference to FIG. 5 is acquired. Then, based on the HDMI input terminal (HDMI port number) of the television apparatus 101 determined from the physical address, the input terminal (HDMI port number) of the AV amplifier 301 is acquire from the input association database.

This allows cancellation of ARC (automatic selection of a path for audio signals in accordance with the CEC standard) for the HDMI cable (in the example illustrated in FIG. 1, cable 12) connecting the AV amplifier 301 and the television apparatus 101 together. That is, in the example illustrated in FIG. 5, setting the item for HDMI2 to “input 2” allows the input to the AV amplifier 301 to be also switched to “input 2”. Hence, video and audio are output through the user's expected path (the audio is subjected to a reproduction process by the recorder 201 which is different from a reproduction process by the television apparatus 301). The changed setting (input association database) is stored in a predetermined storage area in which data is saved even if a main power supply is turned off, for example, in NVRAM (nonvolatile memory). FIG. 6 shows an example of a changed combination of HDMI ports (the physical addresses of a device that inputs audio signals and the physical addresses of a device that inputs video signals).

Expressions such as the “input 1” and the “input 2” in FIG. 5 are indicative only of identifications when the apparatus comprises a plurality of HDMI ports and are different from actual port numbers or connection names displayed on the television apparatus 101. Any form of expressions may be used provided that the expressions enable the ports (cables used for connections/signal paths configured) to be identified.

FIG. 7 shows another example of the input association database held by the television apparatus.

In FIG. 7, items (ports) shown as “automatic” indicate that the input switching cooperative operation (assignment of the ports) of the AV amplifier 301 has not been changed, that is, the AV amplifier 301 operates as pre-specified in an input switching specification.

More specifically, for input switching for the AV amplifier 301, when a value (port) other than the one indicative of “automatic” is set and the input of the television apparatus 101 is switched to the set port, the input of the AV amplifier 301 is switched to the specified one. However, when the input of the television apparatus 101 is switched to the input of the AV amplifier 301 (in the connection sample illustrated in FIG. 7, “HDMI1”) at any timing, since “[[Routing Change]]” [*. *. *. *], described with reference to FIG. 4, is active, and the switching corresponds to selection of the input 2, to which the AV amplifier 301 is forcibly switched. That is, the command “[[Routing Change]] [*. *. *. * ]” includes a rule for switching the AV amplifier is finally apparatus (the anchor) and thus fixes the input switching. The input switching can be inhibited from being fixed as follows:
(1) The input switching is avoided, and the viewing device is directly selected, or
(2) an external input (port; in the example illustrated in FIG. 7, HDMI1) connected to the AV amplifier 301 is set to a value other than the one for “automatic” (for example, the input is set to the “input 1” to switch to the player apparatus 401 brings the physical address [1. 1. 0. 0] shown in FIG. 4.

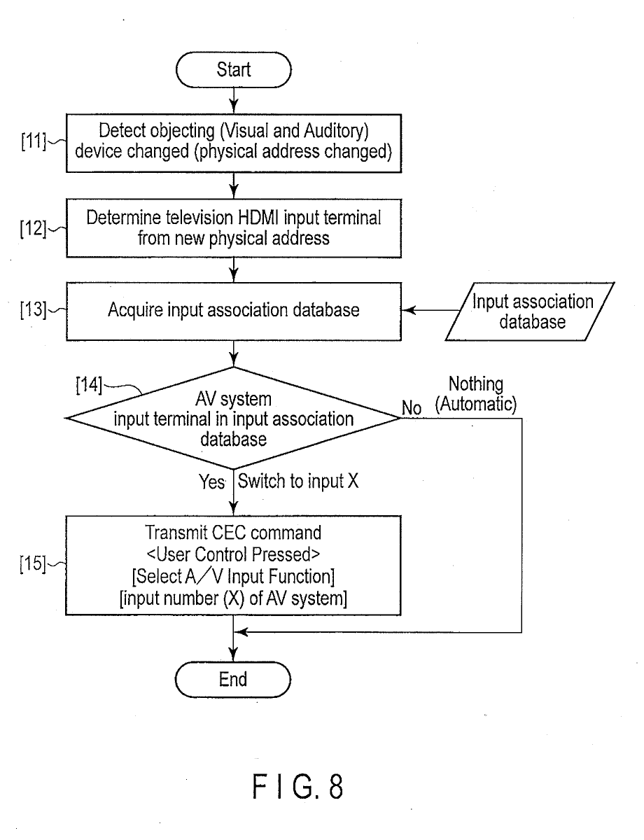

FIG. 8 shows a change in the input switching cooperative operation (assignment of the HDMI ports) described with reference to FIG. 4 and FIG. 5 (or FIG. 7) in terms of software.

First, a change in the physical address of a device (video/audio source [viewing target device]) connected to the television apparatus by HDMI is detected [11].

Based on the new physical address for which the change has been detected, the HDMI input terminal of the television apparatus is determined [12].

An input association database is acquired from the input association database (with reference to the input association database) [13].

Then, the television apparatus determines whether or not the acquired input association database is indicative of an instruction to switch the input terminal of the AV amplifier (the input is to be switched/“automatic” has not been set) [14]. If the input association database is indicative of an instruction for switching [14-YES], the CEC command “[[User Control Pressed]]>[2. 0. 0. 0] [Select A/V Input Function] [X]” corresponding to the switched input terminal of the AV amplifier is transmitted in accordance with the input association database [15].

In contrast, if the input association database is not indicative of an instruction for switching (“automatic” is set) [14-NO], the HDMI connection with the input terminal of the AV amplifier is maintained.

Furthermore, the above-described CEC commands are available within the same vender but may be prepared as vender specific commands specified in the HDMI-CEC standard.

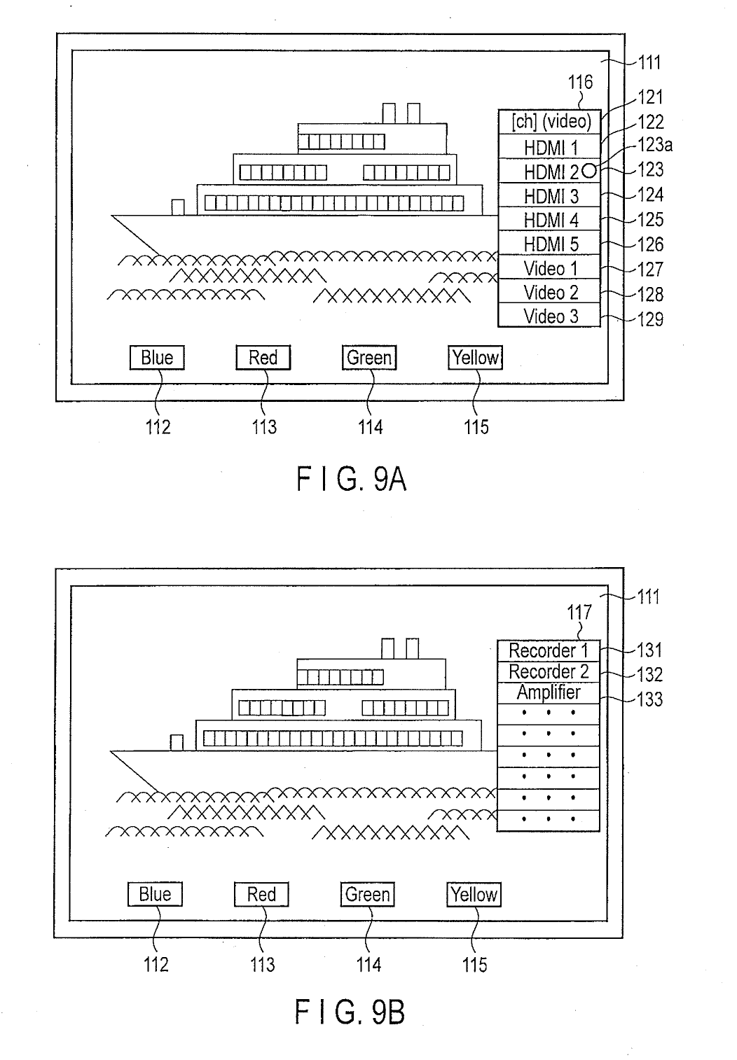

For a change in the input switching cooperative operation (assignment of the HDMI ports) described with reference to FIG. 4 to FIG. 8, whether or not the change is to be applied can be optionally set using a UI display that uses a setting screen illustrated in FIG. 8A and FIG. 8B With a screen display 111 provided on the screen, when the user enters a choice and a decision for the input switching display or operates the input switching key on the remote controller terminal to give an instruction to change the input switching cooperative operation (assignment of the HDMI ports), then as shown in FIG. 9A, a connection change menu 116 is displayed which allows the source of the viewing target provided on the screen display 111, that is, the connection of the viewing target device. If the television apparatus 101 (and the recorder 201) is compatible with terrestrial digital broadcasting, the screen display 111 can accept instructions corresponding to four buttons on the remote control terminal, a “blue” button 112, a “red” button 113, a “green” button 114, and a “yellow” button 115. A unique name for a process for changing the above-described input switching cooperative operation (assignment of the HDMI ports) may be provided as an instruction corresponding to one of the buttons.

The connection change menu 116 includes, for example, a first HDMI connection to a fifth HDMI connection 121 to 125 and other connections (illustrated as videos 1 to 3) 126 to 129, as well as a channel name 121 for a broadcasting station that is the source of a content (program) being viewed. An [HDMI]2 indication 123 in the connection change menu 116 indication includes a [connection change target device indication] 123a that is indicative of a target in the connection change menu, which allows the source of the viewing target (content/program/title), that is, the connection of the viewing target device, to be changed.

When the [connection change target device indication] 123a is selected by, for example, operating the remote control terminal to move a cursor and providing a focus (entering a decision), the screen display 111 shows a connection change target device list 117, as shown in FIG. 9B. In the example illustrated in FIG. 9B, the following are displayed: a recorder 1 indication 131 corresponding to a recorder (2) 501 (provided in the system shown in FIG. 1) which has already been determined to be connected by HDMI as a connection change target device, a recorder 2 indication 132 corresponding to the recorder 201 (in the system shown in FIG. 1), an amplifier indication 133 corresponding to the AV amplifier 301, and the like.

When, for example, the recorder 2 indication 132 corresponding to the recorder 201 is selected by, for example, operating the remote control terminal to move the cursor and providing a focus (entering a decision), the screen shows whether or not any of the connections with the devices (viewing devices) connected via the HDMI cables to the individual HDMI ports (of the television apparatus 101) illustrated in FIG. 7 or FIG. 5 is to be changed (AV system external input setting) (if a connection change has been set, the screen shows the connection target [the name of the switched input terminal]).

If no [connection change target device] is present (the recorder 201 shown in FIG. 1 includes less than two HDMI ports), the television apparatus 101 desirably avoids displaying the connection change menu 116 shown in FIG. 9A even if the user has operated the remote control terminal to provide a user instruction/input (the avoidance of the display does not affect normal operations for the user's viewing of content/programs/titles).

The screen display 111 shown in FIG. 9A and FIG. 9B shows starting of the connection change menu and a display sample on the television apparatus 101. However, if the recorder 201 is manufactured by the same vendor as that of the television apparatus, the connection change menu can be started and displayed on the recorder 201 side. Thus, on the recorder 201 side, the connection change menu can be started and changed using the remote control terminal (remote controller) attached to the recorder 201. If the AV amplifier 301 is prepared by the same vendor as that of the television apparatus 101, the television apparatus 101 and the recorder 201 can be started by operating the remote control terminal attached to the AV amplifier 301 to provide a user instruction/input, for example, [[Wake Up]]/[[Wake on LAN]], so that the above-described connection change (an AV system external input setting) can be carried out.

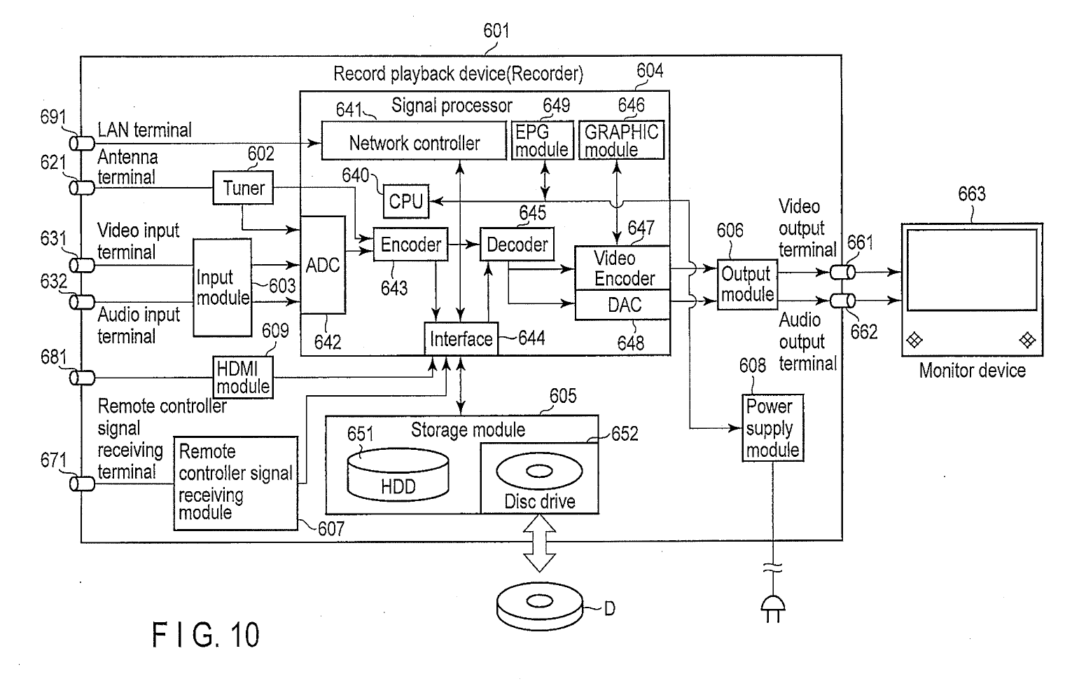

FIG. 10 shows an example of a recorder that can be used as a record playback device (source device) shown in FIG. 1.

A recorder 601 includes at least a tuner 602, an input module 603, a digital signal processor (DSP) 604, a storage module 605, an output module 606, a user operation input module (remote controller signal receiving module) 607, a power supply module 608, and an HDMI module 609 (corresponding to 111 shown in FIG. 1).

The tuner 602 selects a channel in which the program to be recorded is broadcast via an antenna connected to the antenna terminal 621, an optical cable, or the like.

The input module 603 accepts a video signal and an audio signal input via the video signal input terminal 631 and the audio signal input terminal 632.

The DSP 604 includes elements such as the control processing unit (CPU) 640, a network controller 641, an analog-to-digital converter (ADC) 642, an encoder 643, an interface 644, a decoder 645, a user interface graphics processing module (GUI processor) 646, a video encoder (video output processor) 647, a digital-to-analog converter (audio decoder [DAC]) 648, an electronic program guide (EPG) processing module 649, and the like. The HDMI module 609 is connected to the interface 644, but may also be connected to the network controller 641.

The control processing unit 640 controls the operations of the above-described elements and on/off of the main power supply (excluding the secondary circuit for inner control) of the power supply module 608.

The network controller 641 receives a program in a stream format supplied from an external network via a local area network (LAN) terminal 691. The LAN terminal 691 is connected to a relatively small network (home LAN) established in the same building, for example, or a home server (mass-storage device) and a connection network, and may be connected to an external network via a home server, for example. Further, a home LAN or a network should preferably be compatible with the Digital Living Network Alliance (registered trademark) (DLNA) standard.

The analog-to-digital converter (ADC) 642 converts input analog video and audio signals into digital signals, and inputs the converted signals to the encoder 643. When the tuner 602 receives digital broadcasts, the output from the tuner 602 is directly input to the encoder 643.

The encoder 643 encodes the input analog signal (video/audio) into a digital signal. Compression is compliant with a standard such as Moving Picture Experts Group-2 (MPEG-2), MPEG-4 (H.264-AVC), or the like.

The interface 644 is used for data transfer to and from the record device 5, and for input of a control signal from the remote controller signal receiving module 607. A television receiving device (video playback device) 701 shown in FIG. 7 or an AV amplifier, not shown, or a hub is connected to the HDMI module 609 via the HDMI terminal 681. Although not shown, a DVD recorder, a DVD player, or the like, for example, is connected to the AV amplifier. Further, external devices such as an AV amplifier including an HDMI terminal, a PC, a DVD recorder integrated in an HDD, and a DVD player can be connected to the hub. When the HDMI terminal 681 is connected to the hub, it is also possible to provide connection with a network such as the Internet, and to read, play back, and write (record) moving image files (video files) and audio files (audio data) between a PC positioned on the network and a portable telephone or a portable terminal device, not shown.

The decoder 645 decodes the program compressed into MPEG-2 or MPEG-4 (H.264-AVC) format or the like.

The user interface graphics processing module 646 outputs a graphics user interface (GUI) screen display to be displayed on the monitor device 663 connected to the video output terminal 661 and the audio output terminal 662 via the output module 606.

The video encoder (video output processor) 647 synthesizes the video signal and the GUI screen display output from the GUI processing module 646 as necessary, and generates an output video signal to the output module 606 such that the monitor device 663 connected to the video output terminal 661 can display it.

The digital-to-analog converter (audio decoder [DAC]) 648 outputs an audio signal to the output module 606 such that an external speaker, for example, connected to the audio output terminal 662 can play it back.

The EPG processing module 649 acquires EPG data transmitted together with the program in digital DBS or terrestrial digital broadcasting, for example, or EPG data that can be externally acquired via the LAN terminal 691, and holds the acquired data as data on date, time, channel, and program length for displaying the program list in programming a program. The acquired EPG data is stored in a predetermined area in a memory device, not shown, or an HDD 651.

The storage module 605 includes a HD (Hard disk) within the HDD 651 or on a DVD-standard optical disc D loaded in a disc drive device 652, for example, and records a program in the HD in the HDD 651 or the optical disc D in the disc drive device 652, or plays back an already recorded program. By recording a program in a semiconductor memory (memory card) in addition to the disc drive device 652, a reader/writer (not shown) may also be prepared for playing back an already recorded program.

The output module 606 outputs the video signal from the video encoder 647 and the audio signal from the DAC 648 to a playback device connected to the video output terminal 661 and the audio output terminal 662, such as the monitor device and the speaker device.

The remote controller signal receiving module 607 inputs a user operation input received by the remote controller signal receiving terminal 671 to the main control module (CPU) 640 via the interface 644.

The main power supply of the power supply module 608 can be turned off by the control of the main control module 640. The power supply module 608 turns on the main power supply at the point in time when the reservation time set in the timer portion, not shown, has come, and maintains the operation of each of the above-described elements to an operable state.

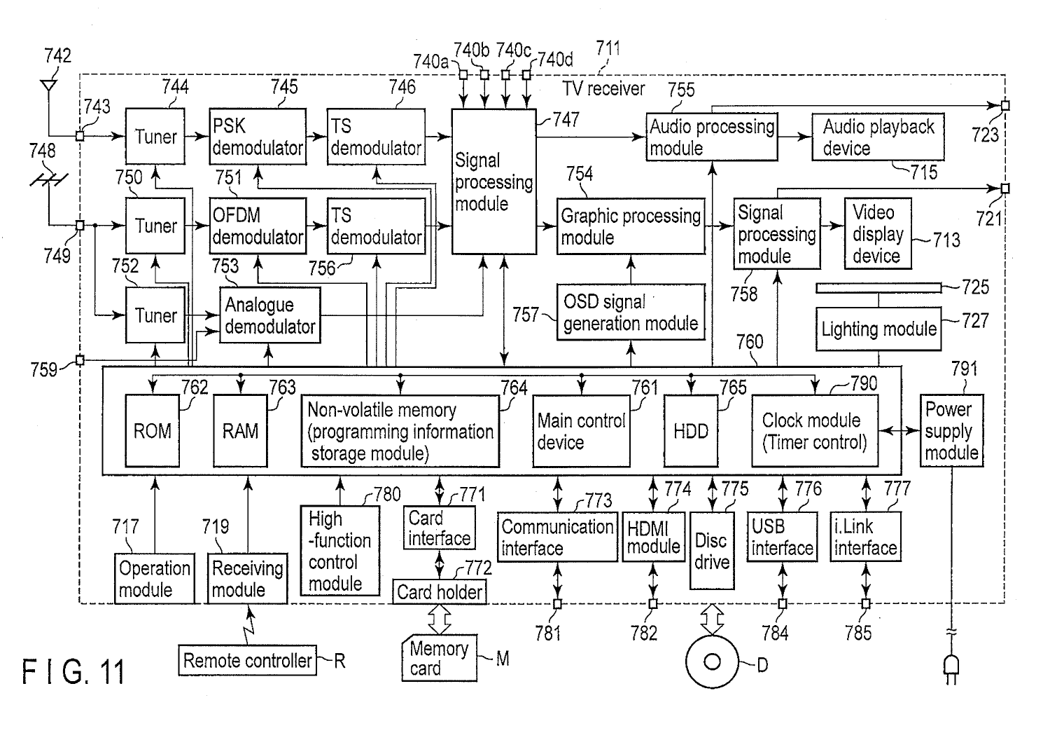

FIG. 11 shows an example of a configuration of a television receiving device that can be used as a video display device (sink device) shown in FIG. 1.

The television receiving device 711 includes a video display device 713 configured to display a video corresponding to the video signal (video data), an audio playback device 715 configured to play back an audio output (audio data) as represented by a speaker, for example, an operation module 717 configured to receive a control instruction (control input) signal from the user, a remote controller reception module 719 configured to receive an operation information (control input) signal via a remote control device R from the user, a control block (control module) 760, and the like. The video display device (display device) 713 is a liquid crystal panel device, for example, and displays a video by selectively letting illumination light (backlight) from the appended illumination device 725 pass through lit by a lighting module 727. Further, the illumination device 725 is lit at a predetermined drive voltage with the lighting module 727 defined based on the brightness of the surrounding and the difference between the consecutive lit time and non-lit time, that is, the temperature of the illumination device 725.

The control module 760 includes a main control device (large-scale IC [LSI] for the main control) 761 referred to as the CPU or the micro processing unit (MPU).

The control module 760 (main control device 761) controls each portion (element) that will be described below according to the information and data externally supplied via the network connection module (communication interface) 773.

The control module 760 also includes a read-only memory (ROM) 762 containing a control program executed by the main control device 761, a random access memory 763 (RAM) configured to provide a work area for the main control device 761, a non-volatile memory (NVM) 764, and an HDD 765.

The NVM 764 also holds messages, decoded schedule information, and the like that are retrieved via the communication interface 773 via the control module 760.

An interface group of an arbitrary number, such as a card interface 771 capable of reading information from the card-shaped medium (memory card) M, which is a semiconductor memory, and writing information to the memory card M, a network communication module (communication interface) 773, an HDMI module 774 (corresponding to 211 of FIG. 1), a disc drive 775 used to read information from the optical disc D, that is, moving image data and audio data, and to write information to the optical disc, a USB interface, and i.Link interface 777 are connected to the control module 760. The control module 760 functions, for example, as external devices, a hub (extension device), or a network control device that agrees with each of the interfaces.

The card interface 771 is capable of reading video and audio files from the memory card M inserted into the card holder 772, and capable of writing video and audio files to the memory card M.

The communication interface 773 is connected to a LAN terminal (port) 781, and receives control information and moving image data supplied via an external device such as a portable terminal device or a mobile PC, not shown, from the remote controller device, according to the Ethernet (registered trademark) standard. By connecting a LAN-compliant hub, the communication interface 773 is capable of connecting devices such as a LAN-compliant HDD (network attached storage [NAS] HDD), a PC, and a DVD recorder integrated in an HDD.

A recorder (video playback device) 601 shown in FIG. 10 as an example or an AV amplifier, not shown, or a hub is connected to the HDMI module 774 via the HDMI terminal 782. Although not shown, a DVD recorder or a DVD player, for example, is connected to the AV amplifier. Further, an external device, such as a DVD recorder or a DVD player, not shown, is connected to the AV amplifier. When the HDMI terminal 782 is connected to a hub, it is also possible to establish connection with a network such as the Internet via a broadband router, for example, or to play back and write (record) moving image files (video data) and audio files (audio data) to and from a mobile telephone, a mobile terminal device, or a mobile terminal.

The disc drive 775 reads or records the information, for example, moving image data and audio data from the DVD-format optical disc D. When the set optical disc is in a CD format, the audio data is read and played back, and the title of the song and the playing time, for example, are output to the video display device 713 such that the video display device 713 can display them.

The USB interface 776 is capable of connecting an HDD, a keyboard, and the like that are formed so as to be accessible via a USB interface, via a hub, not shown, connected to the USB port 784, and is capable of transferring information to and from each of the USB devices. Needless to say, a card reader/writer of a mobile telephone, a digital camera, and a memory card corresponding to the USB interface 776 can also be connected thereto.

Although not shown, external devices such as an audio-visual (AV)-HDD or a digital (D)-Video Home System (VHS), or an external tuner or a Set Top Box (STB) (cable television receiver) can be serially connected to the i.Link interface 777, and information can be transferred between the i.Link interface 777 and an arbitrary connected device.

Although not shown, in addition to each of the interfaces, or in place of an arbitrary one of a plurality of interfaces, a network controller compliant with the DLNA standard, for example, or the Bluetooth (registered trademark), not shown, may be prepared, and a recorder device, an HDD device, or a portable terminal device capable of transferring data may also be connected, as a matter of course.

The control module 760 includes a timer controller (clock module) 790. The clock module 90 manages information such as time, reservation time (date and time) for record programming and the channel to be recorded, and holds the information. The clock module 790 constantly acquires “hour and minute information” which is referred to as Time Offset Table (TOT) in received digital broadcasting via the terrestrial digital tuner 750. That is, the hour and minute management can be performed at the level equal to that of the device integrating a radio clock. Needless to say, time signals can be acquired at a predetermined time every day from an analog predetermined channel received via the terrestrial analog tuner 752. Further, the clock module 790 also functions as a timing module with respect to information for a scheduler function or a messenger function supplied from the portable terminal device. Needless to say, the clock module 790 is capable of controlling on/off (energizing) of the power supply for commercial purposes by the power supply module 791. That is, in cases other than a case where energizing is physically impossible since the plug is pulled off, the secondary battery device (direct-current (DC) 31V, 24V, or 5V) to the control module 760, for example, excluding elements that require relatively large power consumption, such as the video display device 713, the signal processing module 747, and the HDD is usually secured, and the video display device 713, the signal processing module 747, the HDD 765 or the like is activated at a predefined time, as a matter of course.

A satellite digital television broadcast signal received through a BS/CS (satellite wave) digital broadcast receiving antenna 742 is supplied to the satellite digital broadcast tuner 744 through an input terminal 743.

The tuner 744 selects a broadcast signal of a desired channel based on a control signal from the control module 760, and outputs this selected broadcast signal to a phase shift keying (PSK) demodulator 745.

The PSK demodulator 745 demodulates the broadcast signal selected by the tuner 744 based on the control signal from the control module 760 to obtain a transport stream (TS) including a desired program, and outputs the demodulated broadcast signal to a TS demodulator 746.

The TS demodulator 746 performs TS decoding processing with respect to a signal subjected to transport stream multiplexing based on a control signal from the control module 760, and outputs a digital video signal and a digital audio signal of a desired program to the signal processing module 747. Further, the TS demodulator 746 outputs various kinds of data (service information) required to acquire a program (content) supplied based on digital broadcasting, electronic program guide (EPG) information, program attribute information (a program category or the like), subtitle information, and other information to the control module 760.

Moreover, a digital terrestrial broadcast signal received by a terrestrial broadcast receiving antenna 748 is supplied to the digital terrestrial broadcast tuner 750 through an input terminal 749.

The tuner 750 selects a broadcast signal of a desired channel based on the control signal from the control module 760, and outputs the selected broadcast signal to an orthogonal frequency division multiplexing (OFDM) demodulator 751.

The OFDM demodulator 751 demodulates the broadcast signal selected by the tuner 750 based on the control signal from the control module 760 to obtain a transport stream including the desired program, and outputs this stream to a TS demodulator 756.

The TS demodulator 756 performs TS decoding processing with respect to a signal subjected to transport stream (TS) multiplexing under control of the control module 760, and outputs a digital video signal and a digital audio signal of a desired program to the signal processing module 747. It is to be noted that the signal processing module 747 acquires various kinds of data required to acquire a program superimposed on a digital broadcast wave and supplied in this state, electronic program guide (EPG) information, program attribute information (a program category or the like), and other information, and outputs such information to the control module 760.

An analog terrestrial television broadcast signal received by the terrestrial broadcast receiving antenna 748 is supplied to the analog terrestrial broadcast tuner 752 through the input terminal 749, thereby selecting a broadcast signal of a desired channel. The broadcast signal selected by the tuner 752 is demodulated into analog content, i.e., an analog video signal and an analog audio signal by an analog demodulator 753, and then output to the signal processing module 747.

The signal processing module 747 selectively performs predetermined digital signal processing with respect to a digital video signal and a digital audio signal respectively supplied from the PSK demodulator 745 and the OFDM demodulator 751, and outputs the processed signals to the graphic processing module 754 and the audio processing module 755.

To the signal processing module 747 are also connected a plurality of (four in the illustrated example) input terminals 740a, 740b, 740c, and 740d. These input terminals 740a to 740d enable inputting analog video signals and analog audio signals from the outside of the television receiver 711.

The signal processing module 747 selectively digitizes the analog video signals and the analog audio signals respectively supplied from the analog demodulator 753 and the input terminals 740a to 740d, carries out predetermined digital signal processing with respect to the digitized video signals and audio signals, and then outputs the processed signals to the graphic processing module 754 and the audio processing module 755.

The graphic processing module 754 has a function of superimposing an OSD signal generated by an on-screen display (OSD) signal generation module 757 on a digital video signal supplied from the signal processing module 747 and outputting an obtained signal. The graphic processing module 754 can selectively output an output video signal from the signal processing module 747 and an output OSD signal from the OSD signal generation module 757, and can combine both the outputs so that each of the outputs constitutes a half of a screen and can output this combined output.

It is to be noted that the output OSD signal output from the OSD signal generation module 757 can be superimposed on the displayed moving picture in a “semitransparent” state (forming a part of a regular video signal to be permeable) and output in this state when a parameter for α blending is set.

The graphic processing module 754 also performs processing of superimposing subtitle information on a video signal based on a control signal from the control module 760 and the subtitle information when a broadcast signal has a subtitle signal attached thereto and a subtitle can be displayed. It is to be noted that the graphic processing module 754 supplies a moving picture message decoded in the high-function control module 780 or an image showing a scheduler function screen to the image signal processing module 758 through the control module 760.

A digital video signal output from the graphic processing module 754 is supplied to the image signal processing module 758. The image signal processing module 758 converts the digital image signal fed from the graphic processing module 754 into an analog image signal in such a manner that this signal can be reproduced as an image (moving picture/still image) output by the display device 713, i.e., the monitor. Incidentally, it is needless to say that an extended projection device (a projector device) or an external monitor device may be connected as an external device with an output terminal 721 connected with the image signal processing module 758. Further, a DVD recorder device using, e.g., an optical disk conforming to a DVD standard as a recording medium or a video recorder device using a conventional video tape as a recording medium may be connected with the output terminal 721.

The audio processing module 755 is connected to an audio playback device 715, i.e., a speaker or the like, and converts a digital audio signal supplied from the signal processing module 747 into an analog audio signal. It is to be noted that, although not explained in detail, a audio signal (an audio output) may be of course output to an external speaker connected with an output terminal 723, an audio amplifier (a mixer amplifier), or a headphone output terminal prepared as one conformation of the output terminal 723 in such a manner that this audio signal can be reproduced as an audio output.

In the control module 760, information for the scheduler function or the messenger function input to the high-function control module 780 through the communication I/F module 773 is checked for, e.g., double booking with respect to an already set recording reservation, clock time information provided by the clock module 790 and the NVM 764, a date and hour and a channel for a time order (a date order) in the scheduler function, and other factors.

The use of the above-described embodiment allows the user's expected switching operation to be achieved between devices connected together using HDMI. This prevents the user's unexpected operation from being performed due to the priority given to the cooperative operation that conforms to the HDMI-CEC standard.

The embodiment also enables audio to be reproduced in the user's desired grade, for example, enables audio signals to be reproduced using [Dolby true HD], [DTS (Digital Theater System) HD], [Master Audio], or the like.

Moreover, settings can be selected such that video signals can be independently reproduced by the television apparatus, whereas audio signals can be independently reproduced by the AV amplifier. Thus, for example, where video signals are 3D (interpreted as stereoscopic video) signals, a reproduction path allowing only audio signals to be reproduced can be implemented in the AV amplifier.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information reproduction apparatus comprising:
a reception module configured to receive at least one of video and audio input by a source device via a bidirectional interface;
an output module configured to output the audio received by the reception module to an external audio output device via the bidirectional interface;
a detection module configured to detect a connection made between the source device and the external audio output device via the bidirectional interface; and
a controller configured to stop output of the audio from the output module to the external audio output device if the detection module detects the connection between the source device and the external audio output device.

2. The information reproduction apparatus of claim 1, wherein the bidirectional interface conforms to the High-definition Digital Media Interface (HDMI) standard.

3. The information reproduction apparatus of claim 1, wherein the external audio output device comprises an audio reproduction mechanism that is independent of an audio reproduction mechanism in the reproduction module.

4. The information reproduction apparatus of claim 2, wherein the external audio output device comprises an audio reproduction mechanism that is independent of an audio reproduction mechanism in the reproduction module.

5. The information reproduction apparatus of claim 1, wherein upon detecting the connection between the source device and the external audio output device, the reproduction module is configured to accept a setting for giving a priority to supply of audio information from the source device to the external audio output device.

6. A video display apparatus comprising:
a video reproduction module configured to reproduce video information supplied by an output apparatus;
an audio reproduction module configured to reproduce audio information supplied by the output apparatus;
a detection module configured to detect supply of the audio information from the output device to an external audio reproduction apparatus via a bidirectional interface; and
a controller configured to stop reproduction of the audio information by the audio reproduction module if the detection module detects the supply of the audio information from the output device to the external audio reproduction device via the bidirectional interface.

7. The video display apparatus of claim 6, wherein the bidirectional interface conforms to the High-definition Digital Media Interface (HDMI) standard.

8. The video display apparatus of claim 6, wherein if the detection module detects a connection between the output apparatus and the external audio reproduction apparatus, the controller is configured to accept a setting for giving a priority to supply of the audio information from the output apparatus to the external audio reproduction apparatus.

9. The video display apparatus of claim 7, wherein if the detection module detects a connection between the output apparatus and the external audio reproduction apparatus, the controller is configured to accept a setting for giving a priority to supply of the audio information from the output apparatus to the external audio reproduction apparatus.

10. An information reproduction method for use in an information reproduction system comprising at least an output apparatus configured to output a video signal and an audio signal, a reproduction apparatus configured to reproduce the video signal and the audio signal, an external reproduction apparatus configured to reproduce at least the audio signal, and a bidirectional interface configured to connect the output apparatus, the reproduction apparatus, and the external reproduction apparatus together, the information reproduction method comprising:
detecting a connection of the external reproduction apparatus to the output apparatus;
reproducing the video signal in the reproduction apparatus; and
reproducing the audio signal in the external reproduction apparatus.

11. The information reproduction method of claim 10, wherein the bidirectional interface conforms to the High-definition Digital Media Interface (HDMI) standard.
